(19) United States
(12) Patent Application Publication
(10) Pub. No.: US 2017/0137637 A1
(43) Pub. Date: May 18, 2017

(54) CURABLE LIQUID COMPOSITIONS

(71) Applicant: PQ Silicas UK Limited, Cheshire (GB)

(72) Inventors: Gemma MOREA, Cheshire (GB); Mark Sean HEARN, Schweighouse-Thann (FR)

(21) Appl. No.: 15/319,116

(22) PCT Filed: May 28, 2015
(86) PCT No.: PCT/GB2015/051555

§ 371 Date: Dec. 15, 2016

(30) Foreign Application Priority Data
Jun. 16, 2014 (GB) 1410700.7

(51) Int. Cl. C09D 7/00; C08G 18/24; C08G 18/42; C08G 18/73; C09D 7/12; C09D 175/06

(52) U.S. Cl. CPC C09D 7/005; C09D 7/1216; C09D 175/06; C08G 18/42; C08G 18/73; C08G 18/246; C08K 3/34

(57) ABSTRACT

A curable liquid composition for forming a surface coating comprises: a) polyurethane precursor moieties capable of undergoing a polymerisation reaction to generate a polyurethane, b) a catalyst capable of catalysing the reaction of the polyurethane precursor moieties to form the polyurethane, and c) a matting agent which is a precipitated metal silicate.

The present invention relates to polyurethane-based curable liquid compositions for matt-finish surface coatings. The invention relates more particularly to such compositions having improved curing rates as compared with prior art polyurethane-based matt-finish compositions. The invention also relates to methods of coating surfaces of substrates using such compositions.

Surfaces are often coated with a polyurethane in order to impart a variety of properties, such as chemical, stain, weathering and corrosion resistance. Coatings may be provided on a variety of surfaces, such as on metals for architectural construction and food canning applications, and on wood surfaces for furniture and flooring applications.

Polyurethane coatings are typically produced from two-component (“2K”) systems in which separate formulations of (i) polyhydroxy compounds, and (ii) polyisocyanate compounds are mixed together and applied to a surface. Once mixed, the compounds are able to react in a polymerisation reaction to produce the coating (known as “curing” and/or “drying”). Alternatively, a single component (“1K”) system can be used in which a blocked polyisocyanate is supplied together with a polyhydroxy compound in a pre-mixed composition. The composition is applied to a surface and then heated in order to remove the blocking group on the polyisocyanate. Once removed, polymerisation is able to take place between the polyisocyanate and polyhydroxy components to produce the coating.

Catalysts are often used in both 1K and 2K systems to accelerate curing processes. Typically, metal compounds (such as tin-compounds) or tertiary amines are used for this purpose.

Depending on the application, it may be desirable to provide a coating having a matt-finish. This is typically achieved by incorporating particulate silica as a matting agent into the curable composition used to produce the coating.

Silica matting agents can, however, retard the curing process. As a result, matt-finish coatings often require longer drying times than coatings without matt-finishes (typically referred to as “gloss finish” coatings), particularly when the compositions used to form such coatings are cured at room temperature. This retardation causes delays in manufacturing processes, since time must be allowed for the compositions to cure before subsequent processes can occur. Metal sheets, for example, may be coated and then rolled up into a coil for supply to customers. Coiling cannot, however, proceed until after the coating has cured, thereby introducing a delay.

U.S. Pat. No. 4,507,410 seeks to address the aforementioned retardation issue encountered with curable compositions comprising silica matting agents and discloses catalyst compositions comprised of a tin compound bonded to the surface of a silica compound. Such catalyst compositions are reported to have increased activity over conventional catalysts for use in curable polyurethane-based compositions comprising silica matting agents. However, production of such catalysts presents an additional step in the manufacture of curable compositions and it would be desirable to offer a solution not requiring such an additional step.

It is an object of the present invention to obviate or mitigate the abovementioned disadvantages.

According to a first aspect of the present invention, there is provided a curable liquid composition for forming a surface coating, the composition comprising:
a) polyurethane precursor moieties capable of undergoing a polymerisation reaction to generate a polyurethane,
b) a catalyst capable of catalysing the reaction of the polyurethane precursor moieties to form the polyurethane, and
c) a matting agent,

wherein the matting agent is a precipitated metal silicate.

According to a second aspect of the present invention there is provided a substrate having a surface provided with a coating produced by curing a composition according to the first aspect of the present invention.

According to a third aspect of the present invention there is provided the use of a composition according to the first aspect of the present invention in the preparation of cured surface coatings.

According to a fourth aspect of the present invention there is provided a method for coating a surface of a substrate, the method comprising the steps of:

providing a curable liquid composition comprising:
a) polyurethane precursor moieties capable of undergoing a polymerisation reaction to generate a polyurethane,
b) a catalyst capable of catalysing the reaction of the polyurethane precursor moieties to form the polyurethane, and
c) a precipitated metal silicate matting agent,

applying the curable composition to the surface to be coated; and

curing the composition to form a surface coating.

It has been unexpectedly found that significant improvements in the curing times of polyurethane coating compositions can be achieved by using metal silicates in place of conventional silica matting agents. Such silicates provide improved curing times while also maintaining good matting characteristics.

The improvement in curing times confers significant manufacturing advantages. Any delays caused by the need to allow compositions to cure before subsequent manufacturing processes can occur are significantly reduced with the compositions of the present invention. In the production of metal sheets, for example, the metals coated with the compositions of the present invention cure much quicker and therefore may be rolled up into a coil for supply to customers much earlier after coating than would metals coated with prior art compositions comprising silica matting agents. It will be appreciated that the compositions of the present invention are therefore able to reduce production times and thereby improve efficiency overall.

Metal silicates can be used with conventional polyurethane precursors such as polyisocyanates and polyhydroxy compounds without issue. Additionally, the reaction between the polyurethane precursors, in the presence of a metal silicate matting agent as required under the present invention, may be catalysed by catalysts conventionally used in prior art compositions utilising silica matting agents. Furthermore, metal silicates offer utility in both 1K and 2K systems. Accordingly, it is possible simply to exchange silica matting agents conventionally used in prior art compositions with metal silicates without any particular consideration as to the effect of such replacement on the other components in the composition. As a result, the use of metal silicates in place of conventional silica matting agents presents a particularly convenient solution to curing time retardation.

The present invention finds particular utility in applications where the composition is oven-dried in order to accelerate the curing process. The compositions of the present invention have been found to provide exceptionally improved curing times under these drying conditions, to the extent that their drying times may be better than or comparable to the drying times of even “gloss finish” compositions (which are formulated without any matting agents).

Precipitated metal silicates are commercially available from suppliers such as PQ Corporation for use as powder flow aids or as inert liquid carriers. If necessary, these metal silicates can be readily comminuted to provide a desired particle size distribution. These are sold, for instance, under the trade names Alusil® for amorphous precipitated aluminum silicate and Microcal® for amorphous precipitated calcium silicate.

A typical process for preparing an amorphous metal silicate, suitable for use as a matting agent in the invention, is as follows:

A quantity of aqueous solution of an alkali metal silicate, typically having an SiO₂:M₂O molar ratio, where M is an alkali metal (usually Na or K or a mixture thereof), in the range 2.0:1 to 3.5:1, a quantity of aqueous metal salt solution (such as chloride, sulphate or nitrate), and optionally a quantity of mineral acid (such as hydrochloric, nitric or sulphuric acid—if pH reduction is required) are blended together in a reaction vessel with agitation, such as stirring, to form an aqueous reaction mixture. For instance, with calcium or magnesium as the metal, no acid is required, whereas with aluminum as the metal, acid may be added to speed precipitation. The alkali metal silicate solution, any mineral acid solution and metal salt solution are typically supplied together, in the required molar proportions, into a mixing vessel at a rate that ensures that the pH of the reaction mixture is held substantially constant at a value in the range from about 8 to 12, with sufficient agitation to maintain precipitated solids suspended in the resulting slurry. The temperature of the reaction mixture during the introduction of the silicate, the mineral acid, and the metal salt, is maintained at about 30 to 90° C. (for example, 50 to 90° C. in the case of calcium). The period over which these components are combined to form the reaction mixture is typically about 15 to 25 minutes.

Precipitated solid (metal silicate) is then separated from the liquid component of the resulting reaction mixture, for instance by filtration, and the solid is washed and dried. The reaction process may be operated as a batch process or as a continuous process, wherein reacted mixture is removed from the reaction vessel at a rate equal to the sum of the addition rates of the input solutions. The concentration of silicate for the reacted mixture of this continuous or batch process is typically about 3 to 10% by weight of the reaction mixture.

The washed and dried amorphous precipitated metal silicate solid may then be comminuted and classified to provide the desired particle size range, using conventional techniques such as hammer milling, jet milling, fluid energy milling or the like, with classification optionally carried out, such as air classification.

In preferred embodiments of the invention the metal of the metal silicate is selected from one or more metals from groups 2 to 13 of the periodic table, such as aluminum, calcium, magnesium and/or mixtures thereof. The metal silicate is more preferably selected from aluminum or magnesium. The metal silicate may have a molar ratio of MₓO:SiO₂ of 0.05 or more (preferably 0.05 to 0.6), where MₓO represents the stoichiometric formula of metal oxide(s) in the metal silicate with x equal to 2/v where v is the valency of the metal. The metal silicate is preferably an amorphous metal silicate. The metal silicate may be present at a level of 5 to 20% by weight of the total composition (preferably 8 to 15%).

It will be evident that the precipitated metal silicate used in the invention may not necessarily be a stoichiometric metal precipitate. The precipitation may be considered as a reaction between silicic acid and a metal salt to generate a precipitated metal silicate and acid.

The silicate matting agent may be wax-coated to improve the compatibility of the matting agent with the other components of the composition. When wax-coated matting agents are used, the wax content is typically at least 1 wt % and may be up to about 25 wt % based on the total weight of the matting agent. In embodiments the wax content may be up to about 20 wt %, such as up to about 15 wt % or up to about 10 wt % wax. Suitable waxes for coating the matting agents include polyethylene wax, microcrystalline wax (as produced from petrolatum) or the like.

The silicate can be treated with a wax using any method which provides a product in which the silicate is reasonably uniformly coated with the wax. A preferred method comprises passing the silicate and the wax concurrently through a size reduction apparatus such as a microniser or a jet mill. In a preferred method, the wax and the silicate are thoroughly blended in appropriate proportions by mixing in a conventional blender before feeding to the microniser or mill. Alternatively, the wax and silicate can be separately fed at appropriate rates to the microniser or mill. The operating conditions of the mill are fixed so as to ensure that the mixture of silicate and wax reaches a temperature above the melting point of the wax as it passes through the microniser or mill. The silicate is also reduced in size during the micronising or milling process.

The matting agents suitable for use in the invention may be characterised by oil absorption value (using linseed oil). Suitable matting agents will exhibit an oil absorption value from 80 to 400 g/100 g. The oil absorption value is determined by the ASTM spatula rub-out method (American Society of Test Material Standards D 281). The linseed oil used for this test is raw linseed (approximate density 0.93 gram per cm³, general purpose grade) from Fisher Scientific, UK.

The test is based upon the principle of mixing linseed oil with a particulate solid by rubbing with a spatula on a smooth surface until a stiff putty-like paste is formed which will not break or separate when it is cut with the spatula. The oil absorption value can then be derived based on the following equation:

$$Oil absorption value = \frac{grams oil absorbed \times 100}{weight of matting agent in grams}$$

The oil absorption value is expressed as g/100 g. In order to provide good matting performance, the oil absorption value for the matting agent may be 100 g/100 g or more.

In order to provide matting behaviour without causing excessive roughening of the matt surface, the particle size of the matting agent may be such that the D₅₀ median particle size diameter—50% by weight of particles less than D₅₀ in diameter—for the matting agent is from 3 to 15 μm as measured by light scattering. Suitably, the D₉₀ value for the matting agent—90% by weight of particles less than D₉₀ in diameter—is no more than 30 μm.

The particle diameter of the precipitated metal silicate particles is suitably determined by laser diffraction using a Malvern Mastersizer model 200, Malvern Mastersizer 2000 software v 5.60 and a Hydro-G dispersion unit. This instrument, made by Malvern Instruments, Malvern, Worcestershire, utilises Mie theory to calculate the particle size distribution.

The sample is dispersed ultrasonically in water for 2.5 minutes before measurement on a 50% power setting to form an aqueous suspension with an obscuration of 15 to 25%. The pump speed is set at 50% (1250+/−20 r.p.m.) and the stirrer speed is also set at 50% (500+/−5 r.p.m.). Low power 2-5 mW He/Ne laser light (wavelength 632.6 nm) is passed through a flow cell containing the particles dispersed in de-ionised water. A blue light source (wavelength 486 nm) is also used to increase the sensitivity of the instrument to fine particles. The scattered light intensity is measured as a function of angle and this data is used to calculate an apparent particle size distribution, where the Mie model fit to the raw data has a residual of less than 1%. The volume and hence weight percentage of material above or below any specified size is easily obtained from the data generated by the instrument, assuming constant density for the particles. Throughout the present specification, weight based particle size measures are used, assuming constant density, but alternatively, these may be expressed as volume-based particle size measures, without any density assumptions.

There is no particular restriction on the surface area of the precipitated metal silicate in order for it to be effective in the compositions of the present invention. However, the precipitated metal silicate may have a BET surface area of 450 m²/g or less, such as 400 m²/g or less, or 250 m²/g or less, as measured by nitrogen gas adsorption. In embodiments, the precipitated metal silicate may have a BET surface area of 200 m²/g or less, such as 100 m²/g or less and or 70 m²/g or less, as measured by nitrogen gas adsorption. The precipitated metal silicate used as matting agent in the invention may have a BET surface area of 10 m²/g or more, such as 20 m²/g or more, as measured by nitrogen gas adsorption. At lower surface areas, the precipitated metal silicate may exhibit reduced effectiveness as a matting agent and so be ineffective in reducing gloss for the surface of the dried/cured composition.

The pore volume of the matting agents used in the invention is preferably as high as possible, such as 0.1 cm³/g or more as measured by nitrogen gas adsorption. Typically, the matting agent of the invention may exhibit a pore volume of up to 2.0 cm³/g, such as up to 1.5 cm³/g, or up to 1.3 cm³/g. Lower values of pore volume may result in reduced matting performance.

Surface area of the precipitated metal silicates may be measured using standard nitrogen adsorption methods, taking data points in the P/Po range 0.08-0.20 with an ASAP 2420 apparatus supplied by Micromeritics of USA and calculating the BET surface area using a multi-point method as described in the paper by S. Brunauer, P. H. Emmett and E. Teller, J. Am. Chem. Soc., 60, 309 (1938). Samples are outgassed under vacuum at 270° C. for 1 hour before measurement. The sample tube (containing the outgassed sample) is transferred to the analysis station, submerged in liquid nitrogen and a nitrogen isotherm determined.

The pore volume of the metal silicates is measured using the same equipment and methodology to obtain a complete nitrogen adsorption-desorption isotherm for the material. The pore volume is given by the volume of nitrogen adsorbed between P/Po=0.0 and P/Po=0.98 on the adsorption leg.

Preferred embodiments of the present invention utilise precursor moieties which are configured to undergo a polymerisation reaction to produce a cross-linked polyurethane. The configuration of the precursor moieties can be tailored depending on the extent of cross-linking desired in the coating.

Conveniently, the precursor moieties may comprise one or more polyisocyanate compounds and/or one or more polyhydroxy compounds. The composition preferably comprises 30-40 wt % polyisocyanate compounds and 60-70 wt % polyhydroxy compounds based on the total weight of those compounds.

In embodiments where polyisocyanate compounds are used, they may, with preference, be diisocyanate compounds. The polyisocyanate compounds may comprise aromatic compounds, such as diphenylmethane diisocyanate and/or toluene diisocyanate. Alternatively or additionally, the polyisocyanate compounds may comprise aliphatic compounds, such as hexamethylene diisocyanate. Suitable polyisocyanate compounds for use in the present invention are available from Bayer MaterialScience under the trade name Desmodur®.

Suitable polyhydroxy compounds for use in the present invention may be in the form of a diol or higher functionality and may, for example, be polyether polyols or polyester polyols. Suitable polyhydroxy compounds for use in the present invention are available from Bayer MaterialScience under the trade name Desmophen®.

Suitably, the one or more polyisocyanate compounds and/or the polyhydroxy compounds may be branched in order to assist in cross-linking.

In some embodiments, the polyisocyanate compounds and/or the polyhydroxy compounds may be in blocked form.

The catalyst of the composition preferably comprises a metallic catalyst. Suitable metallic catalysts include those comprising aluminum, bismuth, lead, mercury, tin, zinc or zirconium, with tin being preferred. Suitable tin catalysts include tin compounds selected from carboxylates, mercaptides, oxides and thioglycolates.

Preferred tin catalysts include dibutyltin dilaurate and dimethyltin diacetate. The catalyst of the composition may, alternatively or additionally, comprise a tertiary amine. Suitable tertiary amines include pentamethyldipropylenetriamine, triethylenediamine, 1,4-diazabicyclo[2.2.2]octane, 1-azabicyclo[2.2.2]octane, dimethylcyclohexylamine and dimethylethanolamine. The catalyst is preferably present at a level of 0.01 to 0.02% by weight of the total composition.

Because of the detrimental effect that the presence of silica may have upon the curing rate of the compositions of the invention, it is preferred that the composition is free from, or comprises 0.1% by weight or less, of silica.

Typically, other components, such as solvents, will also be present in the curable liquid compositions of the invention. Suitable organic solvents for use with the compositions of the invention include aliphatic, cycloaliphatic and aromatic hydrocarbons, alcohol ethers, alcohol esters and N-methylpyrrolidone. However the compositions of the invention may also be in the form of an emulsion, with an aqueous solvent (by aqueous solvent is meant a solvent containing at least 65% by weight of water) carrying the binder precursor moieties (which may be dissolved in an organic solvent) in the form of an emulsion. Typically, solvent may be present as 10% or more by weight of the total weight of the composition. Suitable emulsifiers may be used to provide a stable emulsion and are well known in the art.

The composition of the invention may contain one or more further components selected from colourants, pigments, anti-corrosive pigments, extenders, dyes, plasticizers, surface-controlling agents, anti-skinning agents, defoaming agents, rheological controlling agents, ultraviolet absorbers or the like. The further components set out in this paragraph will typically be present at levels up to 5% by weight of the compositions of the invention, save for pigments or extenders which may be present at higher levels, such as up to 20% by weight, or even higher. Pigments serve to provide colour and opacity but may also absorb UV as well as contributing to the structural strength of the cured composition. Extenders are mineral components which may also be included in order to replace part of any TiO₂ present as opacifier, for cost saving purposes, to improve application characteristics, to act as flatting agents to further reduce gloss, to inhibit settling of pigments or to provide improved keying for subsequent coats of paint. Common extenders include minerals such as calcium carbonate, talc, barites, kaolin, mica and the like.

In some applications, it may be desirable for the composition to provide a hard, transparent or semi-transparent finish. The compositions of the invention may, therefore, be conveniently formulated as a lacquer.

The method of the fourth aspect of the present invention for the formation of a coating on the surface of a substrate comprises the steps of providing a curable liquid composition comprising:
a) polyurethane precursor moieties capable of undergoing a polymerisation reaction to generate a polyurethane,
b) a catalyst capable of catalysing the reaction of the polyurethane precursor moieties to form the polyurethane, and
c) a precipitated metal silicate matting agent,

applying the curable composition to the surface to be coated; and

curing the composition to form a surface coating.

The coating composition may be formed in a number of ways. In an embodiment, the invention may be practised as a two-component (“2K”) system in which a first composition comprising a polyisocyanate (with free isocyanate groups) is mixed with a second composition comprising a polyol (with free hydroxyl groups) to form a curable composition shortly before application thereof to a surface to be coated. The precipicated silicate matting agent may be incorporated in the first and/or second composition, or may be added as a separate component in forming the mixture. Blending may be carried out using conventional blending techniques known to persons skilled in the art.

Therefore, according to a fifth aspect of the present invention there is provided a combination of components for use in forming a surface coating, the combination comprising:

a first binder precursor,

a second binder precursor copolymerisable with the first precursor,

a catalyst capable of catalysing copolymerisation of the first and second binder precursors, and

a matting agent,

wherein the first and second binder precursors are capable of providing a polyurethane on copolymerisation, and wherein the matting agent is a precipitated metal silicate.

According to a sixth aspect of the present invention there is provided a method of coating a surface of a substrate, the method comprising:

mixing the first and second binder precursor, catalyst, and metal silicate matting agent components of the combination of the fifth aspect to form a coating composition;

applying said composition to the surface to be coated; and

curing the composition.

The components of the composition for forming the coating may alternatively be supplied to the end user as a pre-mixed composition (known as a “1K” system). In such a pre-mixed composition the precursor moieties (such as the isocyanate moieties of the one or more polyisocyanate compounds, and/or the hydroxyl moieties of the one or more polyhydroxy compounds) are blocked to inhibit initiation of polymerisation until desired. Blocking groups can be removed (to enable polymerisation) prior to curing using standard techniques, such as by heating.

The composition may be applied to any surface receptive to a polyurethane coating, with examples of such coatings including metals, wood and plastics; with typical metal substrates including steel and aluminum. In embodiments where the substrate to be coated is a metal in the form of a strip (which strips are often used in architectural purposes, for example), the method may comprise a further step of coiling the metal strip after the step of curing the composition. Coiling facilitates transport, since a coiled strip occupies a smaller surface. However, prior to coiling, the metal strip is typically required to be dried for a significant period in order to ensure that the coating is substantially or completely cured before coiling, otherwise surfaces of the coiled strip can become adhered together. The compositions according to the present invention are particularly suited to coiled metal applications, since their significantly improved curing times allow coiling relatively soon after coating. As a result, overall production times are significantly reduced, since extensive drying periods are not required. Similar benefits are achieved with coatings applied to wood and plastics materials, where rapid curing is also of benefit. In terms of wood used for furniture, for example, the furniture can be stacked relatively soon after coating, since curing times are significantly reduced with the coating compositions of the present invention.

Preferred features described above in relation to any of the abovementioned aspects of the present invention also represent preferred features of the other aspects of the present invention subject to a technical incompatibility that would prevent such a combination of preferred features. Furthermore, it will be evident to the skilled person that advantages set out above in respect of any of the abovementioned aspects of the present invention are also offered by the other aspects.

The invention will now be illustrated with reference to the following non-limiting examples.

### EXAMPLE 1

This Example demonstrates the relative performances, under room temperature drying conditions, of curable polyurethane coating compositions incorporating metal silicate matting agents in accordance with the invention, as compared with (a) curable compositions incorporating conventional silica-based matting agents, and (b) “gloss finish” curable compositions (without any matting agent).

A series of curable compositions was prepared by admixture of three components, namely (i) a polyol formulation, (ii) a polyisocyanate formulation, and (iii) a matting agent. The compositions of the polyol and polyisocyanate formulations are detailed in Tables 1 and 2 below respectively.

TABLE 1
Composition of Polyol Formulation

| | | Parts by |
|---|---|---|
| Component | Component type | weight |
| Desmophen XP2488¹ | Polyol | 50.11 |
| BYK-331² | Additive | 1.38 |
| Dibutyltin dilaurate (DBTL, | Catalyst | 2.66 |
| 1% in methoxy propyl | | |
| acetate)³ | | |
| Butyl acetate/methoxy | Solvent | 44.47 |
| propyl acetate (2:1 ratio) | | |
| Diacetone alcohol | Solvent | 1.38 |

| | |
|---|---|
| TOTAL | 100 |

¹Available from Bayer MaterialScience;
²Available from BYK-Chemie.
³Available from TIB Chemicals AG

TABLE 2
Composition of Polyisocyanate Formulation

| | | Parts by |
|---|---|---|
| Component | Component type | weight |
| Desmodur N3900⁴ | Polyisocyanate | 100 |

| | |
|---|---|
| TOTAL | 100 |

⁴Available from Bayer MaterialScience.

Table 3 below details properties of the matting agents (i.e. component (iii)) used in the curable compositions of the Examples. In Table 3, the comparative matting agents are identified as 1c-3c (the “c” designation referring to “comparison” for ease of reference) and the metal silicates which are in accordance with the invention are identified as 4i-6i (the “i” designation referring to “invention”). A.P. indicates “Amorphous Precipitated” throughout the tables set out below.

TABLE 3
Matting Agents

| Agent | | Particle Size | Surface Area | Pore Volume | Linseed Oil | Molar ratio |
|---|---|---|---|---|---|---|
| No. | Matting Agent | (μm) | (m²/g) | (cm³/g) | Abs. (g/100 g) | (MₓO:SiO₂) |
| 1c | Silica 1 | 10 | 300 | 1.8 | 270 | |
| 2c | Silica 2 | 10 | 400 | 1.9 | 280 | |
| 3c | Silica 3 | 12 | 550 | 1.7 | 250 | |
| 4i | A.P. Ca Silicate | 8 | 26 | 0.14 | 140 | 0.35 |
| 5i | A.P. Mg Silicate S | 20 | 62 | 0.1 | 60 | 0.24 |
| 6i | A.P. Al Silicate R | 6 | 67 | 0.41 | 140 | 0.07 |

Matting agents Silica 1 and 2 (1c and 2c) are available from the PQ Corporation under the following trade names: (1c) “Gasil HP39”; and (2c) “Gasil HP280”.

The series of coating compositions was prepared by admixture of the aforementioned polyol and polyisocyanate formulations (i.e. components (i) and (ii)) with each of the matting agents (i.e. component (iii)) detailed in Table 3 above. The relative proportions of the components in the admixture are as follows:
Polyol formulation: 48.76 parts by weight;
(ii) Polyisocyanate formulation: 41.24 parts by weight; and
(iii) Matting agent: 10 parts by weight. (100 parts total)

A further “gloss finish” coating composition was prepared using the combined polyol and polyisocyanate formulations neat, without any matting agent, for comparison. The relative proportion of the polyol formulation to the polyisocyanate formulation in the gloss finish composition was 54.18 to 45.82 parts by weight respectively (100 parts total).

The coating compositions prepared as detailed above were applied to a surface at 100 μm wet film thickness. The coatings were then allowed to dry at room-temperature (RT, “air dried”).

The coatings were tested to determine their extent of drying as determined by their hardness, and also measured to determine their gloss level. Hardness levels were tested on coatings applied to glass plates using a pendulum hardness tester to obtain a “damping time” in seconds, in accordance with ASTM D 4366. Gloss levels were measured at 60 degrees on coatings applied onto Leneta™ cards using a BYK Multigloss meter.

Hardness was tested after 24 hours of drying, and again after 10 days. The gloss measurements were taken after 24 hours of drying, and again after 14 days.

The hardness and gloss levels of each of the air dried compositions are detailed in Tables 4 and 5 below respectively.

TABLE 4
Air Dried Coating Compositions - Hardness

Hardness (seconds)

| Agent | | After 24 | After 10 |
|---|---|---|---|
| No. | Matting Agent | hours | days |
| N/A | None (gloss finish) | 66 | 141 |
| 1c | Silica 1 | 10 | 165 |
| 2c | Silica 2 | 8 | 171 |
| 3c | Silica 3 | 4 | 162 |
| 4i | A.P. Ca Silicate | 21 | 127 |
| 5i | A.P. Mg Silicate S | 74 | 148 |
| 6i | A.P. Al Silicate R | 53 | 158 |

TABLE 5
Air Dried Coating Compositions - Gloss

Gloss

| Agent | | After 24 | After 14 |
|---|---|---|---|
| No. | Matting Agent | hours | days |
| N/A | None (gloss finish) | 93 | 93 |
| 1c | Silica 1 | 86 | 74 |
| 2c | Silica 2 | 78 | 68 |
| 3c | Silica 3 | 75 | 61 |
| 4i | A.P. Ca Silicate | 48 | 45 |
| 5i | A.P. Mg Silicate S | 66 | 62 |
| 6i | A.P. Al Silicate R | 76 | 71 |

For the gloss finish composition (without any matting agent), a hardness level of 66 s was achieved within 24 hours.

Coating compositions prepared with comparative matting agents Silicas 1 to 3 (1c to 3c respectively) had hardness levels of between 4 and 10 s after 24 hours, and therefore had considerably reduced levels of dryness as compared with the gloss finish composition.

Coating compositions prepared with matting agents A.P. Mg Silicate S and A.P. Al Silicate R (5i and 6i respectively), had hardness levels of 74 and 53 s respectively, and therefore had considerably improved dryness after 24 hours relative to those prepared with comparative matting agents Silicas 1 to 3 (1c to 3c respectively). Matting agent A.P. Mg Silicate S (6i) had a hardness level after 24 hours of 74 s, demonstrating better dryness levels than even the gloss finish composition. Matting agent A.P. Ca Silicate (4i) had a hardness level of 21 and therefore showed improvement over comparative matting agents Silicas 1 to 3 (1c to 3c respectively) after 24 hours.

After 10 days, dryness of all of the matting agents was within acceptable levels.

All of the coating compositions provided an adequate matt-finish, except for the composition with no added matting agent, which provided a gloss finish.

As can be seen, the matting agents in accordance with the present invention provide significantly improved drying times over a 24 hour period as compared with conventional silica-based matting agents. In the majority of cases, the matting agents in accordance with the invention offered only slightly slower drying times than even the gloss finish composition over the same 24 hour period. Moreover, the matting agents in accordance with the present invention offer better or comparable hardness levels in the longer term, 10 day period, as compared with conventional silica matting agents and also the gloss finish composition.

### EXAMPLE 2

The procedure in Example 1 was repeated, save that the coated surfaces were not simply left to dry at RT (as per Example 1), but instead dried briefly in an oven for 45 minutes at 80° C. and then allowed to dry at RT (“oven dried”).

Once again, the coatings were tested to determine their extent of drying as determined by their hardness, and also measured to determine their gloss level in the same manner adopted under Example 1. The hardness and gloss levels of each of the oven dried compositions are included in Tables 6 and 7 below respectively.

TABLE 6
Oven Dried Coating Compositions - Hardness

Hardness (seconds)

| Agent | | After 24 | After 10 |
|---|---|---|---|
| No. | Matting Agent | hours | days |
| N/A | None (gloss finish) | 158 | 172 |
| 1c | Silica 1 | 21 | 160 |
| 2c | Silica 2 | 70 | 164 |
| 3c | Silica 3 | 64 | 146 |
| 4i | A.P. Ca Silicate | 144 | 161 |
| 5i | A.P. Mg Silicate S | 151 | 162 |
| 6i | A.P. Al Silicate R | 148 | 168 |

TABLE 7
Oven Dried Coating Compositions - Gloss

Gloss

| Agent | | After 24 | After 14 |
|---|---|---|---|
| No. | Matting Agent | hours | days |
| N/A | None (gloss finish) | 91 | 92 |
| 1c | Silica 1 | 54 | 36 |
| 2c | Silica 2 | 44 | 38 |
| 3c | Silica 3 | 30 | 28 |
| 4i | A.P. Ca Silicate | 50 | 52 |
| 5i | A.P. Mg Silicate S | 76 | 75 |
| 6i | A.P. Al Silicate R | 58 | 54 |

For the gloss finish composition (without any matting agent), a hardness level of 158 s was achieved within 24 hours.

Coating compositions prepared with comparative matting agents Silicas 1 to 3 (1c to 3c respectively) had hardness levels after 24 hours of between 21 and 70 s, and therefore had considerably reduced levels of dryness as compared with the gloss finish composition.

The coating compositions prepared with the matting agents in accordance with the invention, namely A.P. Ca Silicate, A.P. Mg Silicate S and A.P. Al Silicate R (4i to 6i respectively), had hardness levels between 144 and 151 s after 24 hours, and therefore had considerably improved dryness relative to those prepared with comparative matting agents Silicas 1 to 3 (1c to 3c respectively).

After 10 days, dryness of all of the matting agents was within acceptable levels.

All of the coating compositions provided an adequate matt-finish, except for the composition with no added matting agent, which provided a gloss finish.

As can be seen, and as with the air-drying results detailed in Example 1 above, the matting agents in accordance with the present invention provide significantly improved drying times in oven-drying conditions over a 24 hour period as compared with conventional silica-based matting agents. In some instances, the matting agents in accordance with the invention offered faster drying times than even the gloss finish composition over the same 24 hour period. Moreover, the matting agents in accordance with the present invention offer better or comparable hardness levels in the longer term, 10 day period, as compared with both conventional silica matting agents and also the gloss finish composition.

Given the particularly significant improvement in drying times when using oven-drying conditions, the matting agents of the present invention have specific utility in applications in which rapid-drying is required (such as in the coating of metal strips for subsequent coiling).

Overall, the experimental results for the coating compositions demonstrate the usefulness of the matting agents as set out in the claims to replace conventional silicas as matting agents.

We claim:

1. A curable liquid composition for forming a surface coating, the composition comprising:
a) polyurethane precursor moieties capable of undergoing a polymerisation reaction to generate a polyurethane,
b) a catalyst capable of catalysing the reaction of the polyurethane precursor moieties to form the polyurethane, and
c) a matting agent,
wherein the matting agent is a precipitated metal silicate.

2. (canceled)

3. The curable liquid composition according to claim 1 wherein the metal of the metal silicate is selected from aluminum, calcium, magnesium and mixtures thereof.

4. The curable liquid composition according to claim 1 wherein the metal silicate has a molar ratio of MₓO:SiO₂ of 0.05 or more, where MₓO represents the stoichiometric formula of metal oxide(s) in the metal silicate with x equal to 2/v where v is the valency of the metal.

5. The curable liquid composition according to claim 4 wherein the molar ratio MₓO:SiO₂ is from 0.05 to 0.6.

6. The curable liquid composition according to claim 1 wherein the metal silicate is an amorphous metal silicate.

7. The curable liquid composition according to claim 1 wherein the metal silicate is present at a level of 5 to 20% by weight of the total composition.

8. The curable liquid composition according to claim 7 wherein the metal silicate is present at a level of 8 to 15% by weight of the total composition.

9. (canceled)

10. The curable liquid composition according to claim 1 wherein the precursor moieties comprise one or more polyisocyanate compounds.

11. The curable liquid composition according to claim 10 wherein the isocyanate moieties of the one or more polyisocyanate compounds are blocked.

12. The curable liquid composition according to claim 1 wherein the precursor moieties comprise one or more polyhydroxy compounds.

13. The curable liquid composition according to claim 12 wherein the hydroxyl moieties of the one or more polyhydroxy compounds are blocked.

14. The curable liquid composition according to claim 1, wherein the composition comprises 30-40 wt % polyisocyanate compounds and 60-70 wt % polyhydroxy compounds based on the total weight of those compounds.

15. The curable liquid composition according to claim 1 wherein the composition is a lacquer.

16. The curable liquid composition according to claim 1, wherein the catalyst comprises a metallic catalyst.

17. The curable liquid composition according to claim 16 wherein the metallic catalyst comprises aluminum, bismuth, lead, mercury, tin, zinc or zirconium.

18. The curable liquid composition according to claim 17 wherein the metallic catalyst comprises a tin compound selected from carboxylates, mercaptides, oxides and thioglycolates.

19. The curable liquid composition according to claim 18 wherein the tin catalyst is selected from dibutyltin dilaurate and dimethyltin diacetate.

20. The curable liquid composition according claim 1, wherein the catalyst comprises a tertiary amine.

21. The curable liquid composition according to claim 20 wherein the tertiary amine is selected from pentamethyldipropylenetriamine, triethylenediamine, 1,4-diazabicyclo[2.2.2]octane, 1-azabicyclo[2.2.2]octane, dimethylcyclohexylamine and dimethylethanolamine.

22. The curable liquid composition according to claim 1 wherein the catalyst is present at a level of 0.01 to 0.02% by weight of the total composition.

23. The curable liquid composition according to claim 1, wherein the curable liquid composition is free from, or comprises 0.1% by weight or less, of silica.

24. (canceled)

25. (canceled)

26. A method for coating a surface of a substrate, the method comprising the steps of:
providing a curable liquid composition comprising:
a) polyurethane precursor moieties capable of undergoing a polymerisation reaction to generate a polyurethane,
b) a catalyst capable of catalysing the reaction of the polyurethane precursor moieties to form the polyurethane, and
c) a precipitated metal silicate matting agent,
applying the curable composition to the surface to be coated; and
curing the composition to form a surface coating.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A combination of components for use in forming a surface coating, the combination comprising:
a) a first binder precursor,
b) a second binder precursor copolymerisable with the first precursor,
c) a catalyst capable of catalysing copolymerisation of the first and second binder precursors, and
d) a matting agent,
wherein the first and second binder precursors are capable of providing a polyurethane on copolymerisation, and wherein the matting agent is a precipitated metal silicate.

52. (canceled)

53. (canceled)

54. (canceled)

55. (canceled)

56. A method of coating a surface of a substrate, the method comprising:
mixing the first and second binder precursor, catalyst, and metal silicate matting agent components of the combination according to claim 51 to form a coating composition;
applying said composition to the surface to be coated; and
curing the composition.
